(19) United States
(12) Patent Application Publication
(10) Pub. No.: US 2022/0100642 A1
(43) Pub. Date: Mar. 31, 2022

(54) HIERARCHICAL FRAMEWORK FOR CREATING RESTFUL WEB SERVICES TEST CASES

(71) Applicant: International Business Machines Corporation, Armonk, NY (US)

(72) Inventors: Yamini Danthuluri, Hyderguda (IN); Mohammed Omar, Hyderabad (IN); Swapna Padala, Hyderabad (IN); Hari Kiran Maddela, Hyderabad (IN)

(21) Appl. No.: 17/037,895

(22) Filed: Sep. 30, 2020

(51) Int. Cl. G06F 11/36; G06F 16/955

(52) U.S. Cl. CPC G06F 11/3684; G06F 16/955; G06F 11/3688; G06F 11/3692

(57) ABSTRACT

Methods, computer program products and/or systems are provided that perform the following operations: obtaining an indication to create a new web service test case; providing a plurality of uniform resource identifiers, each uniform resource identifier associated with an available representational state transfer (REST) method; obtaining a set of uniform resource identifier selections for the new test case from the plurality of uniform resource identifiers; generating the new test case with a sequence of REST methods represented by the uniform resource identifier selections and any request parameters associated with the uniform resource identifier selections; storing the new test case; and executing the new test case.

### BACKGROUND

The present disclosure relates generally to the field of web services, and more particularly to providing for the creation of test cases for web services testing automation.

In general, a web service can be a service provided by a computing device to another computing device where the devices communicate with each other over a network, for example, communicating over the World Wide Web using HyperText Transfer Protocol (HTTP). Representational state transfer (REST) is an architecture which defines constraints to be used in creating web services to enable desirable properties. RESTful web services conform to the REST architectural style and provide interoperability between computer systems on a network, such as the World Wide Web.

### SUMMARY

According to an aspect of the present invention, there is a computer-implemented method, computer program product and/or system that performs the following operations (not necessarily in the following order): obtaining an indication to create a new web service test case; providing a plurality of uniform resource identifiers, each uniform resource identifier associated with an available representational state transfer (REST) method; obtaining a set of uniform resource identifier selections for the new test case from the plurality of uniform resource identifiers; generating the new test case with a sequence of REST methods represented by the uniform resource identifier selections and any request parameters associated with the uniform resource identifier selections; and storing the new test case.

### BRIEF DESCRIPTION OF THE DRAWINGS

FIG. 1 is a block diagram view of a first embodiment of a system, according to the present disclosure;

FIG. 2 is a flowchart showing a first embodiment method performed, at least in part, by the first embodiment system;

FIG. 3 is a block diagram showing an example machine logic (for example, software) portion of the first embodiment system; and

FIG. 4 illustrates an example of a test case XML file, according to the present invention.

### DETAILED DESCRIPTION

According to aspects of the present disclosure, systems and methods can be provided to create test cases for web services testing automation. In particular, systems and methods of the present disclosure can provide for writing and executing web services test cases that include a sequence of representational state transfer (REST) methods (e.g., GET, POST, PUT, DELETE, etc.) to verify functionality of RESTful web services. More particularly, embodiments of systems and methods of the present disclosure can provide a hierarchical framework to automate end-to-end test cases which chain a sequence of multiple REST methods together and pass a return value from one method to a succeeding method. Embodiments can provide a framework for web services test case automation that allows for greater flexibility and reduced effort in writing and executing web service test cases.

In general, to verify business functionality of web services, it is usually not sufficient to execute any single REST method like GET, POST, PUT, DELETE, or the like. Rather, there is often a need to invoke multiple methods in a specific sequence to test any given functionality.

Many approaches, such as different script-based tools, provide for either implementing automation of each individual REST method as a test case (e.g., to verify the single method or operation) or implementing a test case having multiple REST methods where each REST method must be executed before it can be added as a test case. In other words, to build a test case it is necessary to build and execute a chain of REST methods in a specific sequential order. However, using these approaches, it is not possible to build this chain of test cases without executing each individual REST method and then adding that executed method to the test case. Further, this also calls for creating variables as assertions (e.g., for succeeding methods in a chain) only after having the executed response string from an executed method. Often, such script-based frameworks are difficult to create and maintain.

As an example, a desired test case to be automated may include the following functionality: (i) login as authorized admin user; (ii) create a new account (assuming the logged in user has privileges to create and delete account); (iii) verify the new account has been created successfully; and (iv) delete the account.

With a script-based approach, this sample test case might be designed in the following manner.

Create a new test case “CreateAccount” with the following steps:
1. Create or write authentication HTTP method (GET/POST) with required parameters;
2. Execute the authentication method;
3. Assert the return authentication token value and store in a variable, for example, ‘authToken’;
4. Then add this HTTP method to the test case “CreateAccount”;
5. Create POST method to create an account with the required parameters, the parameters can include the value of the authentication token (‘authToken’ value) from step 3 above;
6. Execute POST method;
7. Assert the multiple keys like “accountnumber,” “accountname,” etc. from the response and store them in variables such as acc_number and acc_name;
8. Then add this HTTP method to the test case “CreateAccount”;
9. Create GET method to verify whether the above created account has been created properly or not with the variables acc_number/acc_name;
10. Execute GET method;
11. Assert the multiple keys like “accountnumber,” “accountname,” etc. from the response and compare with the above stored values of acc_number and acc_name;
12. Then add this HTTP method to the test case “CreateAccount”;
13. Create DELETE method to delete the above created account with the variables acc_number/acc_name;
14. Execute DELETE method;
15. Then add this HTTP method to the test case “CreateAccount”.

As described above, such script-based approaches/tools provide for creating test case(s) by adding REST methods only after execution of each REST method (e.g., the execute and assert” statements in the above steps).

According to aspects of the present disclosure, embodiments of the systems and methods as disclosed herein can provide a hierarchical test case framework approach to write/create complete RESTful web services test cases without prior execution of the REST methods. Additionally, the systems and methods of the present disclosure provide for including the assertions from a current method execution response string and passing the output value(s) to the next REST method in the sequence as an input value(s). As such, a test case writer can easily create the test case(s) up front without executing each REST method.

This Detailed Description section is divided into the following sub-sections: The Hardware and Software Environment; Example Embodiments; Further Comments and/or Embodiments; and Definitions.

The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

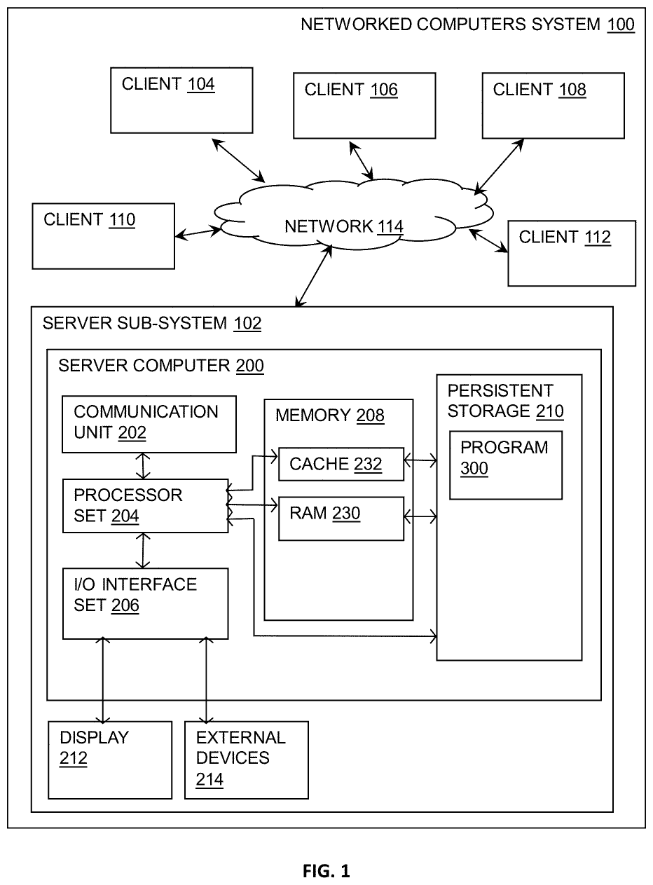

An embodiment of a possible hardware and software environment for software and/or methods according to the present invention will now be described in detail with reference to the Figures. FIG. 1 is a functional block diagram illustrating various portions of exemplary networked computers system 100, which may include: server sub-systems 102, 104, 106; client sub-systems 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine-readable instructions and/or data that is used to create, manage and control certain software functions that will be discussed in detail, below, in the Example Embodiment sub-section of this Detailed Description section. As an example, a program 300 can comprise a web service test case writer, and/or the like.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory device(s) 208 and persistent storage device(s) 210 are computer-readable storage media. In general, memory device(s) 208 can include any suitable volatile or non-volatile computer-readable storage media. It is further noted that, now and/or in the near future: (i) external device set 214 may be able to supply, some or all, memory for sub-system 102; and/or (ii) devices external to sub-system 102 may be able to provide memory for sub-system 102.

Program 300 is stored in persistent storage device(s) 210 for access and/or execution by one or more of the respective computer processors in processor set 204, usually through one or more memories of memory device(s) 208. Persistent storage device(s) 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage device(s) 210.

Program 300 may include both machine readable and performable instructions and/or substantive data (that is, the type of data stored in a database). For example, program 300 may include machine readable and performable instructions to provide for performance of method operations as further disclosed herein. In this particular embodiment, persistent storage device(s) 210 includes a magnetic hard disk drive. To name some possible variations, persistent storage device(s) 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage device(s) 210 may also be removable. For example, a removable hard drive may be used for persistent storage device(s) 210. Other examples include optical and magnetic disks, thumb drives, and smart cards that are inserted into a drive for transfer onto another computer-readable storage medium that is also part of persistent storage device(s) 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device device(s) 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Example Embodiment(s)

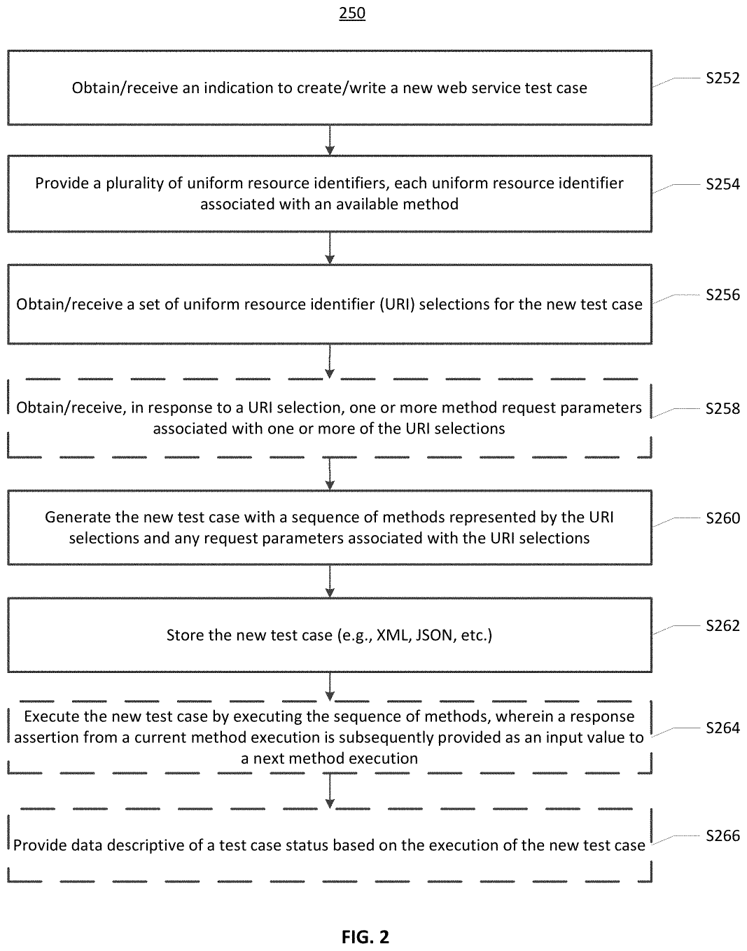

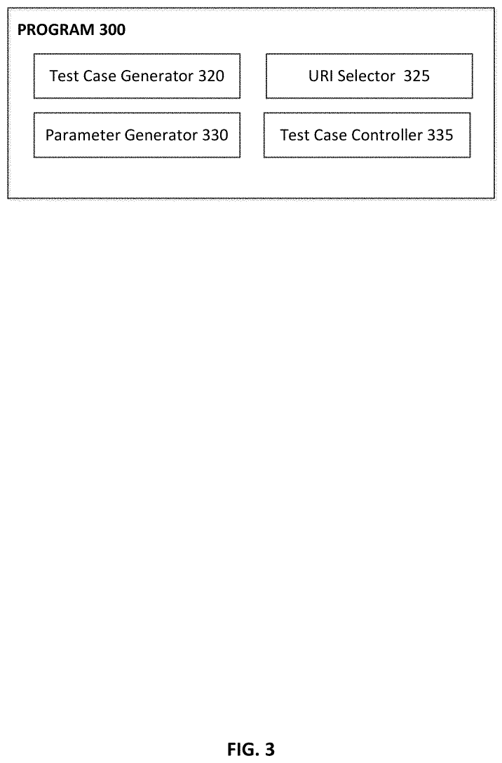

FIG. 2 shows flowchart 250 depicting a computer-implemented method, according to an embodiment of the present invention. FIG. 3 shows a program 300 for performing at least some of the method operations of flowchart 250. Regarding FIG. 2, one or more flowchart blocks may be identified with dashed lines and represent optional steps that may additionally be included, but which are not necessarily required, in the depicted embodiments. This method and associated software will now be discussed, over the course of the following paragraphs, with extensive reference to FIG. 2 (for the method operation blocks) and FIG. 3 (for the software blocks).

As illustrated in FIG. 2, in some embodiments, operations for creation of a web service test case begin at operation S252, where a computing system (e.g., server computer 200 of FIG. 1 or the like) receives an indication (e.g., request, selection, etc.) that a new web service test case should be created/written. As an example, a user (e.g., developer, administrator, analyst, etc.) may wish for a new test case to be written to provide verification of some functionality associated with a web service, such as creation of a new account, and may provide a request to create the new test case, for example, via a graphical user interface (GUI) associated with a test case generator module 320 and/or the like. In some embodiments, the test case generator module 320 may be associated with or included as part of an integrated development environment (IDE). An IDE can provide a user with facilities for software development and may include tools such as a source code editor, build automation tools, debugging tools, and/or the like. The IDE may provide a GUI to allow for the test case generator module 320 to obtain an indication (e.g., from a user, etc.) to initiate the operations to write the new test case for verification of web service functionality.

Processing proceeds to operation S254, where the computing system (e.g., server computer 200 of FIG. 1 or the like) provides a plurality of uniform resource identifiers (URIs) associated with available methods that can be added to the new test case. As an example, test case generator module 320, URI selector module 325, and/or the like can obtain (e.g., generate, retrieve, etc.) one or more URIs that identify available methods (e.g., REST methods, etc.) for the new test case that is to be generated. For instance, in some embodiments, the computing system (e.g., via a GUI associated with the URI selector module 325, etc.) may provide (e.g., display, etc.) the one or more URIs such that they may be selected to be added to the new test case by the user. In some embodiments, the computing system can obtain (e.g., fetch) one or more stored URIs and payload strings, as appropriate, and provide them via the GUI, for example, for selection to write the new test case. In such embodiments, for example, a user may select a URI from a list provided by the GUI and modify the payload string with respective input values, such that the selected URI can be added to the new test case.

Processing proceeds to operation S256, where the computing system (e.g., server computer 200 of FIG. 1 or the like) can obtain a set of uniform resource identifier selections for the new test case. For example, the URI selector module 325 and/or the like can obtain an indication (e.g., selection) of a URI associated with a method that is to be added to the new test case. As an example, in some embodiments, a GUI may provide for a user to select each URI associated with a method (e.g., REST method) that should be added to the new test case. The URI selector module 325 can receive each URI selection for use in creating the new test case and determine any request parameters (e.g., heads, operation, payload string, assertion keys, etc.) that should be obtained for the method.

Optionally, in some embodiments, processing may continue to operation S258, where the computing system (e.g., server computer 200 of FIG. 1 or the like) can obtain any request parameters associated with each URI selection (e.g., REST method, etc.). For example, in response to each URI selection, the test case generator module 320, URI selector module 325, parameter generator 330, and/or the like can determine any request parameters that are required for the method associated with the URI. The request parameters may include headers, operation, payload strings, assertion keys, and/or the like that may be used during future execution of each method. In some embodiments, the user may provide the request parameters (e.g., via the GUI) following the selection of each URI for each method to be added to the new test case. For example, as a user selection of a URI is received via the GUI, the GUI may indicate (e.g., display, etc.) any request parameters that would be needed for future execution of the test case methods. In some embodiments, the parameter generator 330, test case generator module 320, and/or the like can provide for obtaining and/or generating any data associated with the request parameters and provide for writing the request parameter data to the new test case in association with each method added to the test case.

After each URI selection and request parameters associated with the method identified by the URI have been provided, the selected method can be added to the new test case. The operations of obtaining a URI selection and obtaining request parameters associated with the method identified by the URI can be repeated to add additional methods to the new test case until a complete sequence of methods (e.g., REST methods, etc.) desired for testing web service functionality has been obtained. Processing proceeds to operation S260 where the computing system (e.g., server computer 200 of FIG. 1 or the like) can generate the new test case to include a hierarchical sequence of methods (e.g., REST methods) represented by the set of URI selections as well as any request parameters associated with each method identified by a selected URI. For example, the test case generator module 320 can generate (e.g., write, create, etc.) the new test case by providing the selected URIs and the request parameters for each selected URI in an appropriate sequence for the new test case. It should be noted that when generating (e.g., creating, writing, etc.) the new test case with the sequence of methods (e.g., REST methods, etc.), the individual methods do not need to be executed prior to or at the time of test case generation.

Processing proceeds to operation S262, where the computing system (e.g., server computer 200 of FIG. 1 or the like) can store the new test case, for example, as a file in an Extended Markup Language (XML) format, a JavaScript Object Notation (JSON) format, or any other well-formatted or well-structured file format representation. For example, the test case generator module 320 and/or the like can create an appropriate sequence of methods (e.g., REST methods) associated with the selected (e.g., added) URIs and request parameters and write the sequence to a structured format file (e.g., XML file, JSON file, etc.). Once the new test case has been generated, it can be stored for future execution to test the functionality of web services. In some embodiments, generating the test case may include providing static or dynamic variables (e.g., hostname, port, etc.) in the structured formal file. The static/dynamic variable value(s) can be obtained, for example, from external files (e.g., comma separated value (CSV) format, XML format, etc.), for use during execution of the test case.

Optionally, in some embodiments, processing may proceed to operation S264, where the computing system (e.g., server computer 200 of FIG. 1 or the like) can obtain an indication to execute the new test case to test functionality of web services. For example, the test case controller 335 and/or the like can obtain an indication (e.g., from a user via a GUI, etc.) of a test case that should be executed to test web services. The test case controller 335 and/or the like can obtain the stored well-structured format file (e.g., XML, JSON, etc.) for the test case and execute the sequence of methods (e.g., REST methods, etc.) represented by the URIs included in the test case. During execution of the sequence of methods (e.g., REST methods, etc.), the test case controller 335 and/or the like can provide for obtaining assertions from the method execution response of the currently executing method and providing the output value(s) as input values to the next subsequent method in the sequence for execution of that subsequent method. In some embodiments, the test case controller 335 and/or the like can obtain static/dynamic variable value(s), for example, from external CSV files, XML files, and/or the like, for use during execution of the test case.

In such embodiments, processing may optionally proceed to operation S266, where the computing system (e.g., server computer 200 of FIG. 1 or the like) can provide data indicative of a test case status (e.g., pass, fail, etc.). For example, the test case controller 335 and/or the like can obtain test case status in response to the test case execution and provide data indicative of the test case status (e.g. pass, fail, etc.) for review. As an example, the computing system (e.g., via the test case controller 335, etc.) can provide data indicative of the test case status to a GUI for display to a user for analysis of web service functionality.

### Further Comments and/or Embodiments

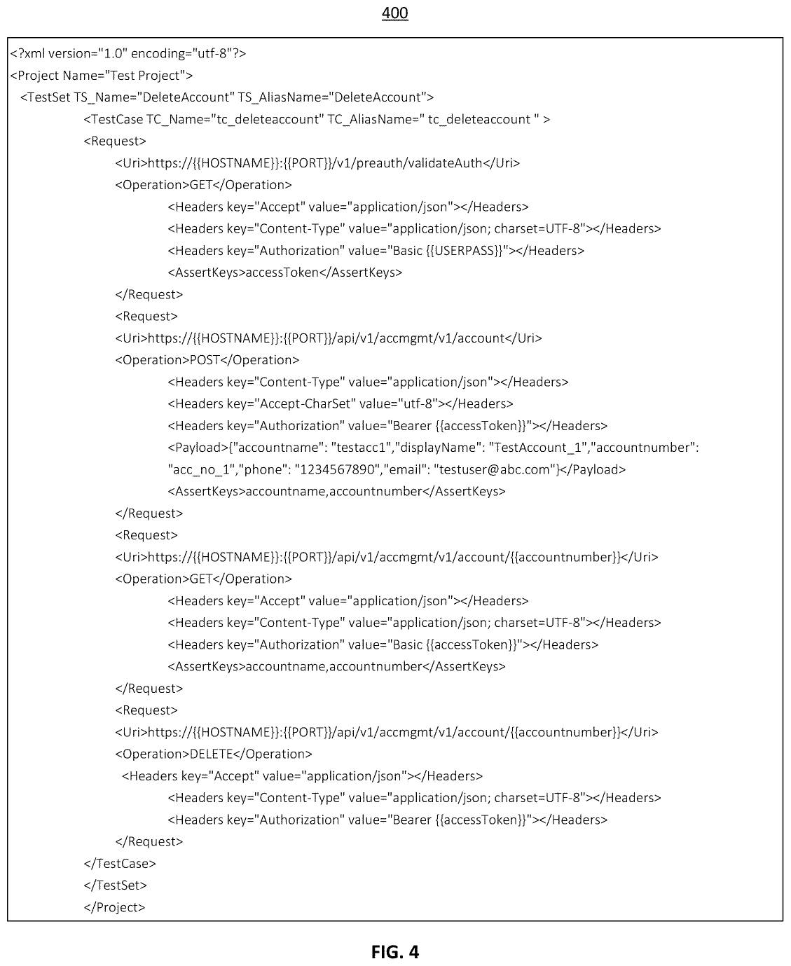

FIG. 4 illustrates an example of a test case XML file 400, according to the present invention. As illustrated in FIG. 4, a test case can be generated (e.g., written, etc.) as described above and stored as a structured format file, such as the example XML provided or any other type of well-formatted or well-structured file. As described with regard to FIGS. 2 and 3, according to aspects of the present disclosure, systems and methods can provide a hierarchical test case framework for generating new test cases to test web service functionality. A sequence of methods (e.g., REST methods, etc.) represented by URIs can be obtained along with any request parameters for each method. The sequence of methods and request parameters can be written and stored as a structured format file, such as an XML file or other type of well-formatted or well-structured file. For example, as illustrated in FIG. 4, a new test case file can be written to test web services functionality and stored as an XML file “TestCase.xml.” The test case file, “TestCase.xml” includes a test case to provide a delete account function.

<?xml version=“1.0” encoding=“utf-8”?>
<Project Name=“Test Project”>
<TestSet TS_Name=“DeleteAccount”
TS_AliasName=“DeleteAccount”>
<TestCase TC_Name=“tc_deleteaccount”
TC_AliasName=“tc_deleteaccount″”>

A first REST method can be selected and added to the test case along with associated request parameters such as headers, operation, and assertion values. Static/dynamic variables can be provided in the test case file, such as “HOSTNAME,” “PORT,” and/or the like. The static/dynamic variable values can be fetched, for example from external CSV files, XML files, and/or the like, during execution of the test case file. As described above regarding FIG. 2, the REST method does not need to be individually executed prior to writing the test case.

```
<Request>
  <Uri>https://{{HOSTNAME}}:{{PORT}}/v1/preauth/
  validateAuth</Uri>
  <Operation>GET</Operation>
    <Headers key=“Accept” value=“application/json”></Headers>
    <Headers key=“Content-Type” value=“application/json;
    charset=UTF-8”></Headers>
    <Headers key=“Authroization” value=“Basic
    {{USERPASS}}”></Headers>
    <AssertKeys>accessToken<//AssertKeys>
</Request>
```

A next REST method can be selected and added to the test case, along with associated request parameters such as headers, operation, and assertion values, as part of the sequence of REST methods to be executed for the test case. As described above, the output value from the prior method execution response (e.g., “accessToken”) can be provided as an input to the subsequent method during execution of the test case.

```
<Request>
  <Uri>https://{{HOSTNAME}}:{{PORT}}/api/v1/accmgmt/v1/
  account</Uri>
  <Operation>POST</Operation>
    <Headers key=“Content-Type”
    value=“application/json”></Headers>
    <Headers key=“Accept-CharSet″ value=“utf-8”></Headers>
    <Headers key=“Authorization” value=“Bearer
    {{accessToken}}”></Headers>
    <Payload>{“accountname″: “testacc1”,“displayName”:
    “TestAccount_1”,“accountnumber”: “acc_no_1”,“Phone”:
    “1234567890”,“email”: “testuser@abc.com”}</Payload>
    <Assert/keys>accountname,accountnumber</AssertKeys>
</Request>
```

A next REST method can be selected and added to the test case, along with associated request parameters such as headers, operation, and assertion values, as part of the sequence of REST methods to be executed for the test case.

```
<Request>
  <Uri>https://{{HOSTNAME}}:{{PORT}}/api/v1/accmgmt/v1/
  account/{{accountnumber}}</Uri>
  <Operation>GET</Operation>
    <Headers key=“Accept” value=“application/json”></Headers>
    <Headers key=“Content-Type” value,“application/json;
    charset=UTF-8”></Headers>
    <Headers key=“Authorization” value=“BASIC
    {{accessToken}}”></Headers>
    <Assert/keys>accountname,accountnumber</AssertKeys>
<Request>
```

A next REST method can be selected and added to the test case, along with associated request parameters such as headers, operation, and assertion values, as part of the sequence of REST methods to be executed for the test case, which in this example, completes the sequence of REST methods.

```
  <Request>
    <Uri>https://{{HOSTNAME}}:{{ PORT}}/api/v1/accmgmt/v1/
    account/{{accountnumber}}</Uri>
    <Operation>DELETE</Operation>
      <Headers key=“Accept” value=“application/json”></Headers>
      <Headers key=“Content-Type” value,“application/json;
      charset=UTF-8”></Headers>
      <Headers key=“Authorization” value=“Bearer
      {{accessToken}}”></Headers>
  </Request>
</TestCase>
</TestSet>
</Project>
```

As illustrated by the example XML file 400 of FIG. 4, embodiments of the present disclosure provide the ability to construct complete RESTful web services test case(s) without prior execution of each individual REST method. Additionally, during execution of a test case, embodiments allow for the output value(s) of assertions from the current method execution response to be passed as input value(s) to a subsequent method execution. In some embodiments, any given test case or test set can then be executed by the XML (or any other type of well-formatted or well-structured file) file name attribute.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
obtaining an indication to create a new web service test case;
providing a plurality of uniform resource identifiers, each uniform resource identifier associated with an available representational state transfer (REST) method;
obtaining a set of uniform resource identifier selections for the new test case from the plurality of uniform resource identifiers; and
generating the new test case with a sequence of REST methods represented by the uniform resource identifier selections and any request parameters associated with the uniform resource identifier selections, wherein generating the new test case comprises generating the new test case without prior execution of the REST methods represented by the uniform resource identifier selections.

2. The computer-implemented method of claim 1, further comprising, in response to obtaining each uniform resource identifier selection in the set of uniform resource identifier selections, obtaining one or more method request parameters associated with each uniform resource identifier selection.

3. The computer-implemented method of claim 2, wherein the method request parameters associated with one or more of the uniform resource identifier selections are selected from the group consisting of:
uniform resource identifier;
headers;
operations;
payload strings; and
assertion strings.

4. The computer-implemented method of claim 1 further comprising:
receiving a request to execute the new test case to verify web service functionality;
executing the new test case by executing the sequence of REST methods, wherein a response assertion from a current REST method execution is subsequently provided as an input value to a next REST method execution; and
in response to the new test case execution, providing data descriptive of a test case status based on the execution of the new test case.

5. The computer-implemented method of claim 4 further comprising obtaining one or more stored static variables for the execution of the new test case.

6. (canceled)

7. The computer-implemented method of claim 1, wherein the set of uniform resource identifier selections are received via a graphical user interface associated with an integrated development environment.

8. The computer-implemented method of claim 1, wherein the new test case is stored as an Extensible Markup Language file; a Java Script Object Notation file; or a well-structured file format.

9. A computer program product comprising a computer readable storage medium having stored thereon:
program instructions programmed to obtain an indication to create a new web service test case;
program instructions programmed to provide a plurality of uniform resource identifiers, each uniform resource identifier associated with an available representational state transfer (REST) method;
program instructions programmed to obtain a set of uniform resource identifier selections for the new test case from the plurality of uniform resource identifiers; and
program instructions programmed to generate the new test case with a sequence of REST methods represented by the uniform resource identifier selections and any request parameters associated with the uniform resource identifier selections, wherein generating the new test case comprises generating the new test case without prior execution of the REST methods represented by the uniform resource identifier selections.

10. The computer program product of claim 9, wherein the computer readable storage medium has further stored thereon:
program instructions programmed to obtain one or more method request parameters associated with each uniform resource identifier selection in response to obtaining each uniform resource identifier selection in the set of uniform resource identifier selections.

11. The computer program product of claim 10, wherein the method request parameters associated with one or more of the uniform resource identifier selections are selected from the group consisting of:
uniform resource identifier;
headers;
operations;
payload strings; and
assertion strings.

12. The computer program product of claim 9, wherein the computer readable storage medium has further stored thereon:
program instructions programmed to obtain a request to execute the new test case to verify web service functionality;
program instructions programmed to execute the new test case by executing the sequence of REST methods, wherein a response assertion from a current REST method execution is subsequently provided as an input value to a next REST method execution; and
program instructions programmed to, in response to the new test case execution, provide data descriptive of a test case status based on the execution of the new test case.

13. The computer program product of claim 9, wherein the computer readable storage medium has further stored thereon:
program instructions programmed to obtain one or more static or dynamic variables for the execution of the new test case.

14. (canceled)

15. The computer program product of claim 9, wherein the set of uniform resource identifier selections are received via a graphical user interface associated with an integrated development environment.

16. A computer system comprising:
a processor(s) set; and
a computer readable storage medium;
wherein:
the processor set is structured, located, connected and/or programmed to run program instructions stored on the computer readable storage medium; and
the stored program instructions include:
program instructions programmed to obtain an indication to create a new web service test case;
program instructions programmed to provide a plurality of uniform resource identifiers, each uniform resource identifier associated with an available representational state transfer (REST) method;
program instructions programmed to obtain a set of uniform resource identifier selections for the new test case from the plurality of uniform resource identifiers; and
program instructions programmed to generate the new test case with a sequence of REST methods represented by the uniform resource identifier selections and any request parameters associated with the uniform resource identifier selections, wherein generating the new test case comprises generating the new test case without prior execution of the REST methods represented by the uniform resource identifier selections.

17. The computer system of claim 16, wherein the stored program instructions further include:
program instructions programmed to obtain one or more method request parameters associated with each uniform resource identifier selection in response to obtaining each uniform resource identifier selection in the set of uniform resource identifier selections.

18. The computer system of claim 17, wherein the method request parameters associated with one or more of the uniform resource identifier selections selected from the group consisting of:
uniform resource identifier;
headers;
operations;
payload strings; and
assertion strings.

19. The computer system of claim 16, wherein the stored program instructions further include:
program instructions programmed to obtain a request to execute the new test case to verify web service functionality;
program instructions programmed to execute the new test case by executing the sequence of REST methods, wherein a response assertion from a current REST method execution is subsequently provided as an input value to a next REST method execution; and
program instructions programmed to, in response to the new test case execution, provide data descriptive of a test case status based on the execution of the new test case.

20. (canceled)
